(19) United States
(12) Patent Application Publication
(10) Pub. No.: US 2012/0182601 A1
(43) Pub. Date: Jul. 19, 2012

(54) Demodulator Using MEMS Chip for Adjusting The Phase

(76) Inventors: Bin Chen, Shenzhen (CN); Xiaohui Ren, Shenzhen (CN)

(21) Appl. No.: 13/380,037

(22) PCT Filed: Dec. 29, 2010
(86) PCT No.: PCT/CN2010/080430

§ 371 Date: Dec. 22, 2011

(51) Int. Cl. G02F 2/00

(52) U.S. Cl. 359/325

(57) ABSTRACT

The present patent application provides a demodulator using MEMS chip for adjusting the phase, which comprises a first interferometer. The difference of the first optical path and the second optical path is an integer multiple of the light speed. A MEMS chip is arranged in at least one optical path of the first interferometer, the MEMS chip is used to adjust the phase of the interference light. The present patent application using MEMS chip for adjusting the phase and phase difference, and also monitor the location of the output beam waveform of the first interferometer and the second interferometer to guide the MEMS chip adjusting the phase difference of the two optical paths. Therefore the adjusting of the phase is more precise by using MEMS chip.

### FIELD OF THE PATENT APPLICATION

The present patent application relates to optical communication, and particularly relates to a demodulator using MEMS chip for adjusting the phase.

### BACKGROUND

Differential quadrature Phase-Shift Keying (DQPSK) is a kind of linear narrow-band digital modulation technology developed from quadrature Phase-Shift Keying (QPSK) and Offset quadrature Phase-Shift Keying (OQPSK). DQPSK modulation format has many advantages comparing with other modulation formats. In Wavelength Division Multiplexing (WDM) system, DQPSK signal has high tolerance to noise, nonlinear effect and coherent crosstalk. By employing DQPSK code pattern, the tolerance of chromatic dispersion and polarization mode dispersion can be improved without compensation. DQPSK has higher spectrum efficiency. Currently, DQPSK is the only modulation format which allows processing of 40 Gbit/s data-rate in a 50 GHz channel communication system.

DQPSK modulation can double the system capacity comparing with DPSK modulation. This is because the DQPSK transmits two bits by every symbol, while DPSK only transmits one bit by every symbol. In addition, the sensitivity of DQPSK receiver is improved by 3 dB comparing with the traditional phase-shift keying formats.

DQPSK demodulation signal can be received only after converting the phase information to intensity information. It's necessary to add a demodulator at the receiving side of the differential phase-shift key signal. Thus the design of DQPSK demodulator is a key work in the DQPSK transmitting technology. The technical advantages along with the grown of industry chain will make the DQPSK demodulation technology enter into full commercialize following the DPSK/DQPSK modulation technology.

DQPSK demodulation module is the upgrade of the DPSK demodulation module. Before describing the DQPSK demodulation principle, it's necessary to describe the DPSK demodulation principle. The traditional DPSK demodulation module adopts the delay interference. The difference of time delay from the beam splitter to the two completely reflecting mirrors match with the rate of the signal to be demodulated. Thus the actual signal can be extracted from the phase-shift of the adjacent bit signal. For example, the rate of signal to be demodulated is 40 Gbit/s, the two DQPSK demodulation modules counted as two matched DLI, i.e., the combination of two matched DPSK demodulation modules. Same as the DPSK demodulation module, the two DPSK demodulation modules in the DQPSK demodulation module form two interfering optical paths. The two interfering optical paths have time delay difference matching the rate of signal to be demodulated. The optical beam demodulated from the DQPSK demodulation modules needs to meet following relationship: the interfering beam I1 and I2 demodulated from the first interferometer have phase difference of 180 degree, the interfering beam Q1 and Q2 demodulated from the second interferometer have phase difference of 180 degree, the beam I1 and I2 have phase difference of 90 degree with the beam Q1 and Q2. As shown in FIG. 1, to ensure the demodulation relationship, the DQPSK demodulation module comprising demodulation module I and demodulation module Q, wherein a primary adjustable heater H1 and a dithering adjustable heater H2 are arranged in the optical path of the first arm I1 of the demodulation module I and the first arm Q1 of the demodulation module Q, a 90 degree adjustable heater H3 is arranged in the optical path of the second arm Q2 of the demodulation module Q. FIG 1a shows the waveform of the beam I from the demodulation module I and beam Q from the demodulation module Q. As shown in FIG. 1b, by adjusting the primary adjustable heater H1, the waveform of beam I and beam Q shift at a same direction. As shown in FIG. 1c, by adjusting the dithering adjustable heater H2, the waveform of beam I and beam Q vibrate at lower amplitude. As shown in FIG. 1d, by adjusting the 90 degree adjustable heater H3, the waveform of beam Q is adjusted till the realization of the 90 degree phase difference of beam I and beam Q.

However, the three heaters H1, H2 and H3 need to be adjusted respectively to realize the adjustment of the phase. This causes much inconvenience.

### SUMMARY

In order to solve the above mentioned problem, the present patent application provides a demodulator using MEMS chip for adjusting the phase, which includes a first interferometer, the difference between the first optical path and the second optical path of the interferometer is equal to the time interval, multiple by the light speed; a MEMS chip is arranged in at least one optical path of the first interferometer, the MEMS chip is used to adjust the phase of the interference light

According to one aspect of the present patent application, further includes a second interferometer, the phase difference of the first interferometer and the second interferometer is 90 degree, the MEMS chip is used to adjust the phase of the first interferometer and the second interferometer

According to another aspect of the present patent application, the MEMS chip adjusts the phase of the first interferometer and the second interferometer simultaneously.

According to another aspect of the present patent application, the MEMS chip dither the phase of the first interferometer and the second interferometer simultaneously, monitor the location of the exiting beam waveform of the first interferometer and the second interferometer, and feedback for the adjustment of the phase difference of the two optical paths.

According to another aspect of the present patent application, the adjustment amount of the phase by MEMS chip is corresponding to the voltage.

According to another aspect of the present patent application, the first interferometer and the second interferometer are combined into one interferometer. The demodulator further includes an input collimator to collimate and couple the input beam; a beam splitter to split the input beam into beam A and beam B. The interferometer includes a beam splitter to split the beam A and beam B into first beam and second beam equally, a first dual fiber collimator to input the beam A and output the second beam of beam A after the first interferometer, a second dual fiber collimator to input the beam B and output the second beam of beam B after interferometer, a reflector to reflect the first beam of beam A and the first beam of beam B to same side of the input beam, and output via second output collimator and fourth output collimator.

According to another aspect of the present patent application, the beam splitter can be a trapezoid splitting prism.

According to another aspect of the present patent application, the reflector is a triangular reflector

### BRIEF DESCRIPTIONS OF THE DRAWINGS

The accompanying drawings illustrate embodiments of the patent application and, together with the description, serve to explain the principles of the patent application.

FIG. 1 illustrates the demodulation system in the demodulator of prior art.

FIG. 1a-FIG. 1d illustrate the waveform shifting during the adjusting of the demodulator of prior art.

FIG. 2 is the structure diagram of the first embodiment of the DQPSK demodulator using MEMS chip for adjusting the phase in the present patent application.

FIG. 3 and FIG. 4 are the structure diagrams of the second embodiment of the DQPSK demodulator using MEMS chip for adjusting the phase in the present patent application.

FIG. 5a and FIG. 5b illustrate the waveform shifting of the first interferometer and the second interferometer adjusted by MEMS chip.

### DETAILED DESCRIPTION

The embodiments of the DQPSK demodulator using MEMS chip for adjusting the phase of the present patent application will be further described with reference to the drawings.

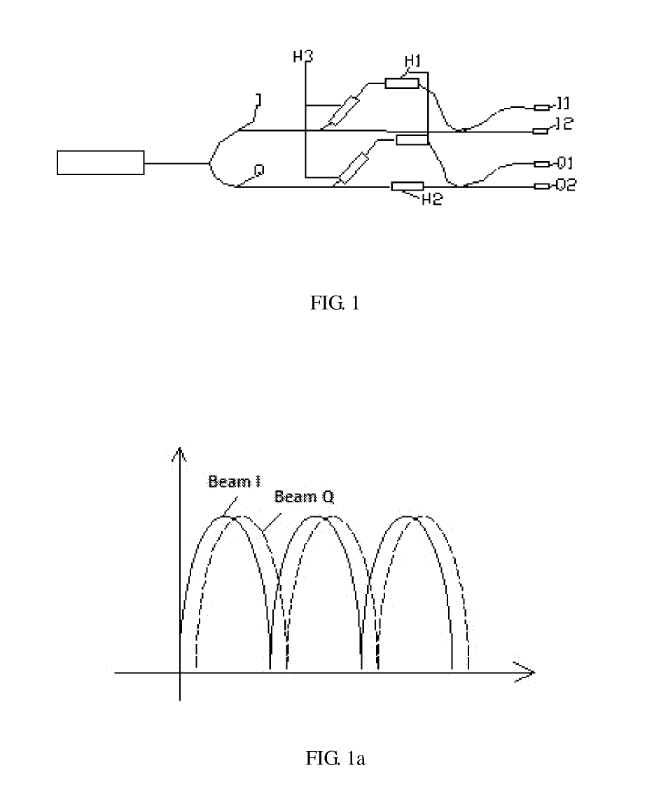

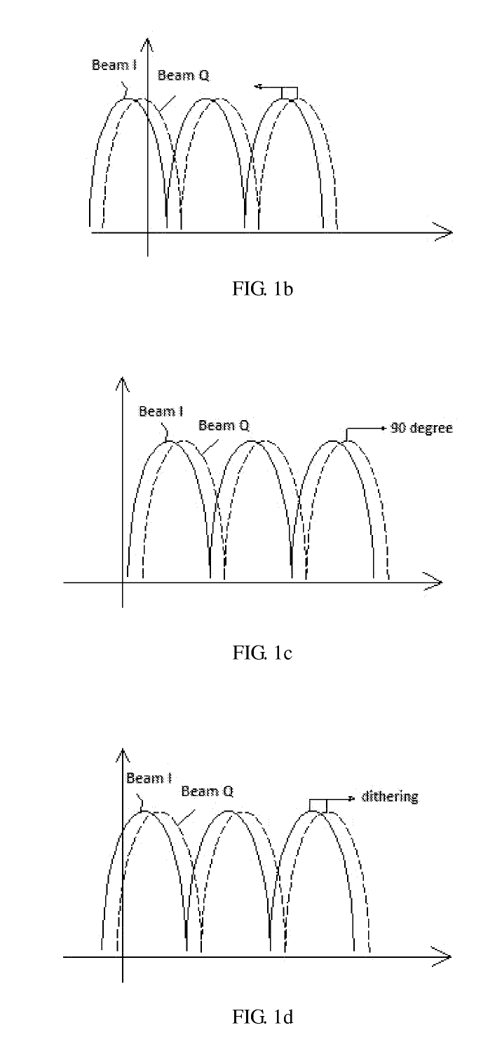

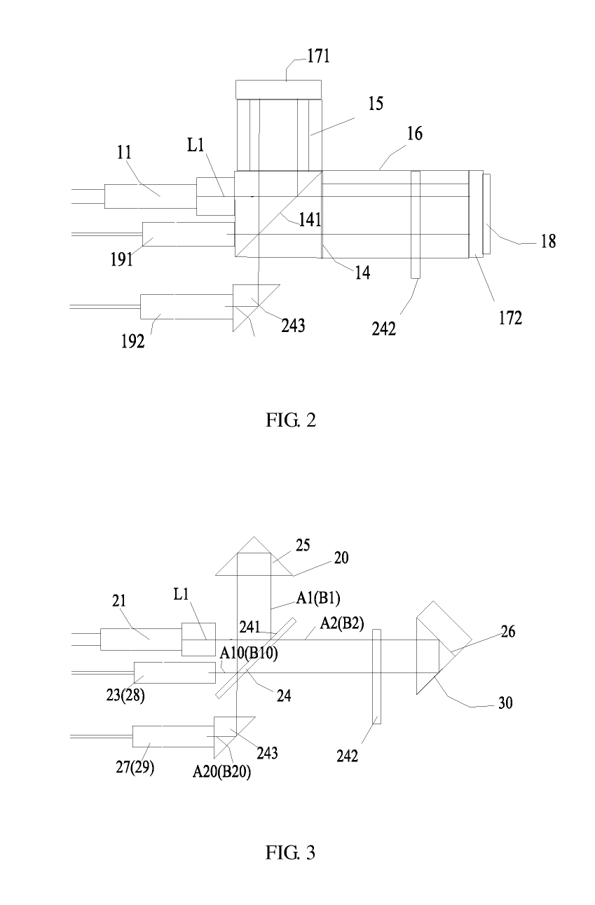

FIG. 2 is the structure diagram of the DQPSK demodulator using MEMS chip for adjusting the phase in the present patent application. As show in FIG. 1, the input port 11 receives the input signal L. The input port 11 includes a first collimator 12, connected to the power splitter 14 of the interferometer. The power splitter 14 has a splitting coating 141. The right surface of the power splitter 14 connected to the first splitting arm 15. A second splitting arm 16 is located on the top of the power splitter 14. A first reflector or first reflecting film 171 is arranged at the end of the first splitting arm 15 which is away from power splitter 14. A second reflector 172 is arranged at the end of the second splitting arm 16. The second reflector 172 coupled with a MEMS chip 18.

The optical path of this embodiment is as below: beam L input from the input port 11 and is split into horizontal beam L1 and vertical beam L2 by the beam splitting coating 141 of the power splitter 14. The beam L1 passes through the first splitting arm 15 and then is reflected to power splitter 14 by the first reflector 171. The beam L1 is then split into beams L1x and L1y by the splitting film 141. The beam L2 passes through the second splitting arm 16 and then is reflected to power splitter 14 by the second reflector 172. The beam L2 is then split into beams L2x and L2y. The beams L1x and L2y, the beams L2x and L1y, interfere respectively and produce interfering beams I1 and I2. The interfering beams I1 and I2 output via the first output port 191 and the second output port 192.

The MEMS chip 18 is attached to the first reflector 172. A certain voltage is applied to the MEMS chip 18 to change the length of the second optical path, and thus to adjust the phase of the interfering beam.

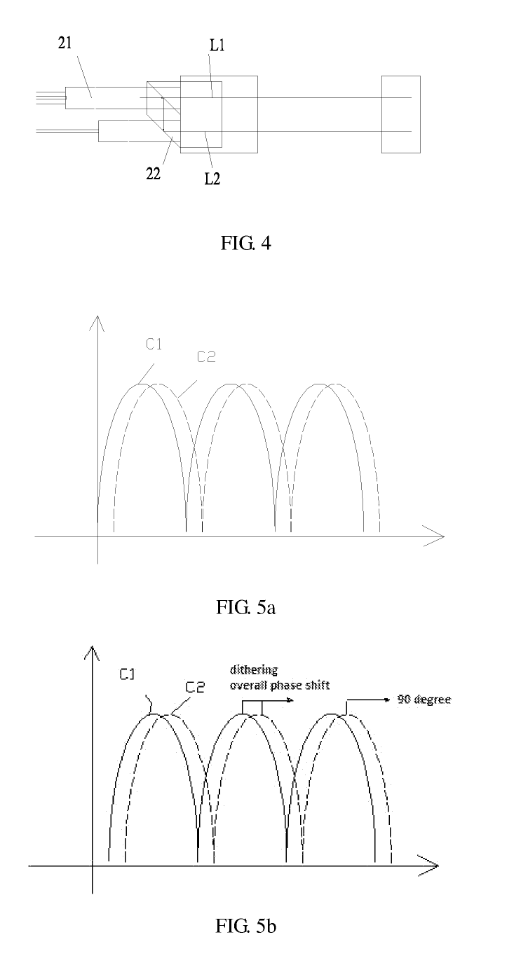

FIG. 3 and FIG. 4 are the structure diagrams of the second embodiment of the DQPSK demodulator using MEMS chip for adjusting the phase in the present patent application. As shown I FIG. 2 and FIG. 3, the initial input beam L of the DQPSK signal input via the first collimator 21 and then split into two parallel beams, i.e., first beam L1 and second beam L2, by splitting prism 22. The first beam L1 and second beam L2 pass through a same DLI demodulation module.

The first beam L1 inputting into DLI demodulation module will be described detailed in the following. The first beam L1 with light signals pass through delay interferometer 20 and then produce two interfering output beam: first splitting beam A1 and second splitting beam A2. The first splitting beam A1 is perpendicular with input beam L1. The second splitting beam A2 returns and couples with the second fiber collimator 23 to output. The DLI demodulation module has a structure of Michelson interferometer, wherein a 50/50 splitter 24 aslant aligns at 45 degree, a first triangular reflector 25 align horizontally, a second triangular reflector 26 align vertically. The input beam L1 pass through the splitting surface of a precise 50/50 splitter 24 and then split into first beam A1 and second beam A2. The first beam A1 pass through a certain distance and reach the first triangular reflector 25. Then the first beam A1 is reflected into the splitting surface 241 of the splitter 24. The splitting surface 241 split the first beam A1 into reflected beam A11 and transmitted beam A12. The second beam A2 transmits via the splitting surface 241 and reflects onto splitting surface 241 by the second triangular reflector 26. The splitting surface 241 split the second beam A2 into reflected beam A21 and transmitted beam A22. The reflected beam A11 and transmitted beam A22, the transmitted beam A12 and the reflected beam A21, interfere respectively and produce interfering beams A10 and A20. The interfering beam A10 output via the second fiber collimator 23. The interfering beam A20 output via the third fiber collimator 27.

Basing on the same principle of the optical path, the second beam L2 splits into the first beam B1 and second beam B2 via splitter 24. Then the first beam B1 and second beam B2 produce interfering beams B10 and B2 after reflecting and interfering. The interfering beam B10 output via the forth fiber collimator 28. The interfering beam B20 output via the fifth fiber collimator 29. The beams L1 and L2 are split into two parallel beams by prism. Therefore, in the front view of this embodiment, the second fiber collimator 23 blocks the forth fiber collimator 28. The third fiber collimator 27 blocks the fifth fiber collimator 29.

As shown in FIG. 3 and FIG. 4, in this embodiment, a tuning module 242 is arranged between the second triangular reflector 26 and the splitter 24. The splitter 24 and the first triangular reflector 25 for a first interfering arm. The splitter 24 and the second triangular reflector 26 for a second interfering arm. The tuning module 242 adjusts the optical path difference between the first interfering arm and the second interfering arm by adjusting the temperature. The non-reflecting surface of the second triangular reflector 26 connects with a MEMS chip 30. The external circuits of the MEMS chip 30 changes the applied voltage and thus adjust the phase.

FIG. 5a shows how the MEMS chip 30 adjusts the phase. The first interferometer output the light beam waveform C1. The second interferometer output the light beam waveform C2. As shown in FIG. 5b, the MEMS chip 30 adjusts the waveform C1 and C2 to 90 degree phase difference by adjusting the applied voltage and shifts the waveform C1 and C2 at a same direction simultaneously. The MEMS chip 30 also can dither the waveform C1 and C2 at a small range and monitor the location of the output beam waveform of the first interferometer and the second interferometer to guide the MEMS chip adjusting the phase difference of the two optical paths.

That is to say, the MEMS chip 30 can adjust the phase difference of the first interferometer and the second interferometer, and can adjust the phase of the first interferometer and the second interferometer simultaneously. The MEMS chip 30 dither the phase of the first interferometer and the second interferometer at a small range, and monitor the location of the output beam waveform of the first interferometer and the second interferometer to guide the MEMS chip adjusting the phase difference of the two optical paths.

There are advantages of the present patent application. The present patent application using MEMS chip for adjusting the phase and phase difference, and also monitor the location of the output beam waveform of the first interferometer and the second interferometer to guide the MEMS chip adjusting the phase difference of the two optical paths. Therefore the adjusting of the phase is more precise by using MEMS chip.

Although the patent application has been described with respect to certain embodiments, the description is not regarded as limiting of the patent application. The alternative changes or modifications of aspects of the embodiments of the patent application fall within the spirit of the present patent application.

1. A demodulator using MEMS chip for adjusting the phase, comprising a first interferometer, the difference between the first optical path and the second optical path of the interferometer is equal to the time interval, multiple by the light speed; a MEMS chip is arranged in at least one optical path of the first interferometer, the MEMS chip is used to adjust the phase of the interference light.

2. The demodulator using MEMS chip for adjusting the phase in claim 1, further comprising a second interferometer, the phase difference of the first interferometer and the second interferometer is 90 degree, the MEMS chip is used to adjust the phase of the first interferometer and the second interferometer.

3. The demodulator using MEMS chip for adjusting the phase in claim 2, wherein the MEMS chip adjust the phase of the first interferometer and the second interferometer simultaneously.

4. The demodulator using MEMS chip for adjusting the phase in claim 2, wherein the MEMS chip dither the phase of the first interferometer and the second interferometer simultaneously, monitor the location of the exiting beam waveform of the first interferometer and the second interferometer, and feedback for the adjustment of the phase difference of the two optical paths.

5. The demodulator using MEMS chip for adjusting the phase in claim 1, wherein the adjustment amount of the phase by MEMS chip is corresponding to the voltage.

6. The demodulator using MEMS chip for adjusting the phase in claim 1, wherein the first interferometer and the second interferometer are combined into one interferometer. The demodulator further comprising an input collimator to collimate and couple the input beam; a beam splitter to split the input beam into beam A and beam B, the interferometer comprising a beam splitter to split the beam A and beam B into first beam and second beam equally, a first dual fiber collimator to input the beam A and output the second beam of beam A after the first interferometer, a second dual fiber collimator to input the beam B and output the second beam of beam B after interferometer, a reflector to reflect the first beam of beam A and the first beam of beam B to same side of the input beam, and output via second output collimator and fourth output collimator.

7. The demodulator using MEMS chip for adjusting the phase in claim 6, wherein the beam splitter can be a trapezoid splitting prism.

8. The demodulator using MEMS chip for adjusting the phase in claim 6, wherein the reflector is a triangular reflector.

9. The demodulator using MEMS chip for adjusting the phase in claim 2, wherein the adjustment amount of the phase by MEMS chip is corresponding to the voltage.

10. The demodulator using MEMS chip for adjusting the phase in claim 3, wherein the adjustment amount of the phase by MEMS chip is corresponding to the voltage.

11. The demodulator using MEMS chip for adjusting the phase in claim 4, wherein the adjustment amount of the phase by MEMS chip is corresponding to the voltage.

12. The demodulator using MEMS chip for adjusting the phase in claim 2, wherein the first interferometer and the second interferometer are combined into one interferometer. The demodulator further comprising an input collimator to collimate and couple the input beam; a beam splitter to split the input beam into beam A and beam B, the interferometer comprising a beam splitter to split the beam A and beam B into first beam and second beam equally, a first dual fiber collimator to input the beam A and output the second beam of beam A after the first interferometer, a second dual fiber collimator to input the beam B and output the second beam of beam B after interferometer, a reflector to reflect the first beam of beam A and the first beam of beam B to same side of the input beam, and output via second output collimator and fourth output collimator.
